(19) United States
(12) Patent Application Publication
(10) Pub. No.: US 2015/0261947 A1
(43) Pub. Date: Sep. 17, 2015

(54) ELECTRONIC DEVICE, SYSTEM AND METHOD

(71) Applicant: Kabushiki Kaisha Toshiba, Tokyo (JP)

(72) Inventors: Hironori Motoe, Ome Tokyo (JP); Hiroshi Aiba, Ome Tokyo (JP)

(21) Appl. No.: 14/497,182

(22) Filed: Sep. 25, 2014

(30) Foreign Application Priority Data
Mar. 12, 2014 (JP) 2014-048866

(51) Int. Cl. G06F 21/34; G06F 21/31

(52) U.S. Cl. CPC G06F 21/34; G06F 21/316

(57) ABSTRACT

According to one embodiment, an electronic device attachable to a user includes a sensor, a first controller and a second controller. The sensor detects the movement of the electronic device. The first controller wirelessly communicates with a terminal device. The second controller controls the terminal device based on a signal state of the sensor and a communication state of the first controller.

### CROSS-REFERENCE TO RELATED APPLICATIONS

This application is based upon and claims the benefit of priority from Japanese Patent Application No. 2014-048866, filed Mar. 12, 2014, the entire contents of which are incorporated herein by reference.

### FIELD

Embodiments described herein relate generally to an electronic device attachable to a user's body, and a system and method using the electronic device.

### BACKGROUND

In general, personal computers (hereinafter, PCs) have a lock function to prevent illegal operation by a third party. The lock function is automatically activated if an input operation is not performed within a predetermined period. In this case, however, to release the lock function, a troublesome operation to, for example, input a password is needed. The same is done of a log-in function for a single PC shared among a plurality of users. Namely, whenever the log-in function is activated, personal information must be input.

On the other hand, there is a system for realizing lock/unlock or log-in/log-out processing by sending to a PC via Bluetooth (trademark) information from a user carrying on electronic device.

In this case, however, a Bluetooth (trademark) signal does not have strong radiative power and therefore gives rise to degraded position detection precision (it has a detection precision corresponding to about 1 to 2 m only). Accordingly, for instance, a PC may not be unlocked or logged into even through the user is near the PC. Similarly, the PC may not be locked or logged out from although the user is away from the PC.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing the external appearance of a computer (terminal device) according to a first embodiment;

FIG. 2 is a view showing the external appearance of a wearable device (electronic device) according to the first embodiment;

FIG. 3 is a block diagram showing the system configuration of the computer according to the first embodiment;

FIG. 4 is a block diagram showing the system configuration of the wearable device according to the first embodiment;

FIG. 5 is a view showing the configuration of a control program executed by the computer of the first embodiment;

FIG. 6 is a view showing the configuration of a control program executed by the wearable device of the first embodiment;

FIG. 7 shows a state in which the computer of the first embodiment is in a locked state;

FIG. 8 shows a state in which the computer of the first embodiment is touched by a user;

FIG. 9 is a graph showing the signal waveforms of a triaxial accelerator sensor employed in the wearable device of the first embodiment;

FIG. 10 is a flowchart showing the operations of the wearable device and computer of the first embodiment;

FIG. 11 is a flowchart showing the operations of a wearable device and a computer according to a second embodiment;

FIG. 12 is a flowchart showing the operations of a wearable device and a computer according to a third embodiment;

FIG. 13 is a view for explaining a gesture function employed in the touch pad of a computer according to a fourth embodiment;

FIG. 14 is a flowchart showing an operation performed in the fourth embodiment when a computer condition is registered;

FIG. 15 is a flowchart showing the operations of a wearable device and the computer according to the fourth embodiment;

FIG. 16 is a flowchart showing the operations of a wearable device and a computer according to a fifth embodiment;

FIG. 17 is a view showing a state in which a computer according to a sixth embodiment is being used by a user;

FIG. 18 is a view showing a state in which the user leaves the computer of the sixth embodiment;

FIG. 19 is a flowchart showing the operations of a wearable device and a computer according to the sixth embodiment; and

FIG. 20 is a flowchart showing the operations of a wearable device and a computer according to a seventh embodiment.

### DETAILED DESCRIPTION

Various embodiments will be described hereinafter with reference to the accompanying drawings.

In general, according to one embodiment, an electronic device includes a sensor, a first controller and a second controller. The sensor detects movement of the electronic device. The first controller wirelessly communicates with a terminal device. The second controller controls the terminal device based on a signal state of the sensor and a communication state of the first controller.

### First Embodiment

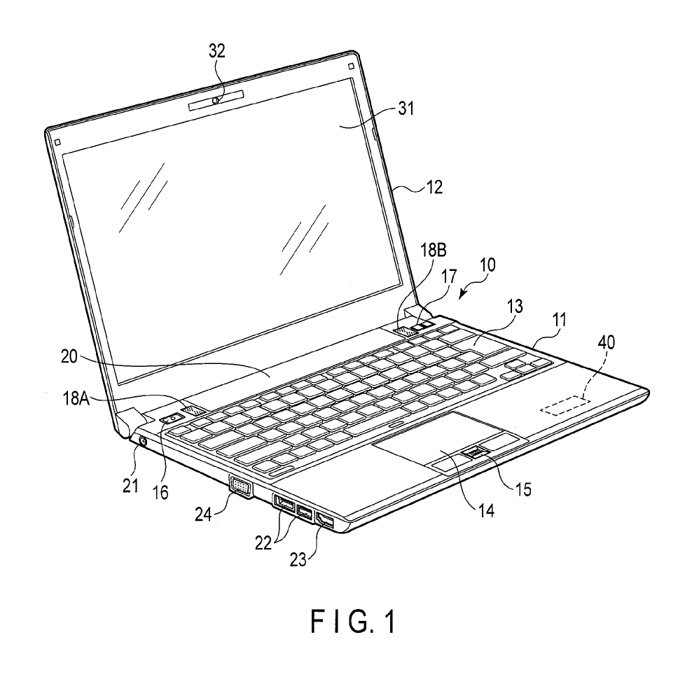

Referring first to FIG. 1, a description will be given of a terminal device according to a first embodiment. This terminal device is realized as a notebook personal computer, a tablet terminal or any other information processing device. In the description below, it is assumed that this terminal device is realized as a notebook personal computer 10.

FIG. 1 is a perspective view of the computer 10, obtained when viewed from the front and showing a state in which its display unit is open.

The computer 10 comprises a computer main unit 11 and a display unit 12. The display unit 12 incorporates a liquid crystal display (LCD) 31. Further, a camera (web camera) 32 is provided on the upper end of the display unit 12.

The display unit 12 is attached to the computer main unit 11 such that it is rotatable between an open position in which the upper surface of the computer main unit is exposed, and a closed position in which the upper surface of the computer main unit 11 is covered by the display unit 12. The computer main unit 11 has a thin box-shaped casing. A keyboard 13, a touch pad 14, a fingerprint sensor 15, a power supply switch 16, a plurality of function buttons 17 and loud speakers 18A and 18B are provided on the upper surface of the computer main unit 11.

Further, a power supply connector 21 is incorporated in the computer main unit 11. The power supply connector 21 is attached to a side, for example, the left side, of the computer main unit 11. An external power supply device is detachably connected to the power supply connector 21. As the external power supply device, an AC adaptor can be used. The AC adaptor is a power supply device configured to convert commercial power (AC power) into DC power.

A battery 20 is detachably attached to, for example, the rear end of the computer main unit 11. The battery 20 may be a one built in the computer 10.

The computer 10 is driven by power from the external power supply or from the battery 20. In the state where the external power supply is connected to the power supply connector 21, the computer 10 is driven by the power from the external power supply. The power from the external power supply is also used to charge the battery 20. When no external power supply is connected to the power supply connector 21, the computer 10 is driven by the power from the battery 20.

The computer main unit 11 also incorporates a plurality of USB ports 22, a High-definition multimedia interface (HDMI) output terminal 23 and an RGB port 24.

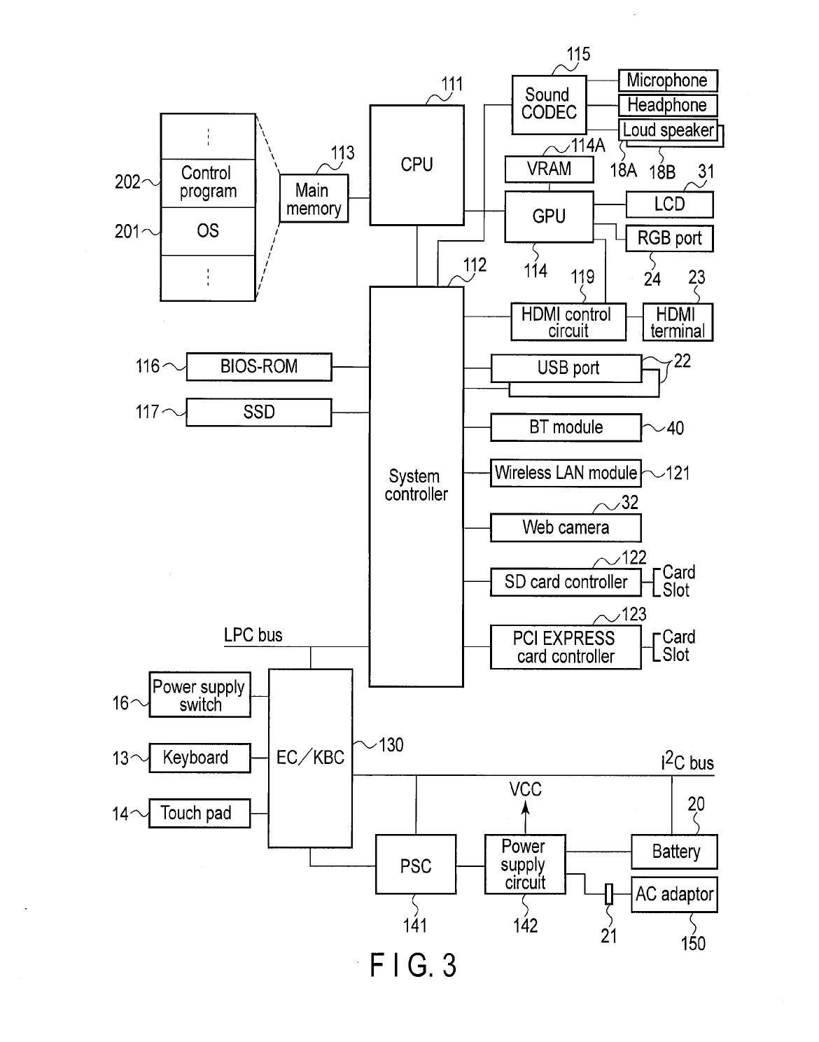

In the first embodiment, the computer 10 is provided with a BT module 40. BT means Bluetooth (trademark). The BT module 40 is a communication controller configured to realize short-range wireless communication between devices within a predetermined range (several meters to several tens meters). The system configuration of the computer 10 will be described later in detail with reference to FIG. 3.

A wearable device used as an electronic device according to the first embodiment will now be described. The wearable device is a portable terminal device, and is also called “a wearable terminal.”

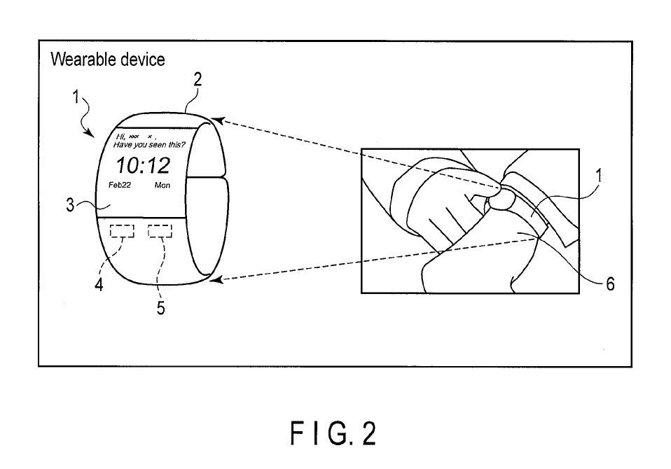

FIG. 2 shows the external appearance of the wearable device 1.

The wearable device 1 has a housing formed 2 attachable to a human body. As the wearable device 1, a bracelet-type device, which is attachable to, for example, a wrist of the user, a simple device, which has no display and is attachable to part of the user body, a glass-type device, which can be used as glasses, and the like, can be pointed out. In the description below, it is assumed that the wearable device 1 is realized as the bracelet-type device.

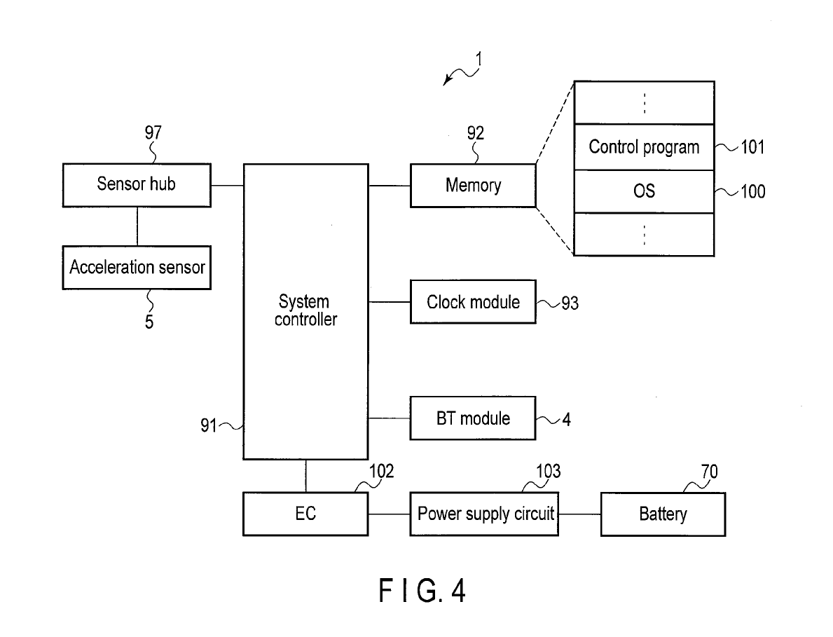

The wearable device 1 (housing formed 2) is attached to part of a user's hand, more specifically, to the wrist 6 of the right or left hand. The wearable device 1 comprises a display 3, a BT module 4 and an acceleration sensor 5. The system configuration of the wearable device 1 will be described later in detail with reference to FIG. 4.

BT pairing is already established between the wearable device 1 and the computer 10. The wearable device 1 is driven by a battery, and is configured to provide various types of information to a user wearing the wearable device 1. The wearable device 1 can synchronize data stored in the wearable device 1 with data stored in the computer 10, using the BT module 4. For instance, it can synchronize user schedule data stored in the computer 10, with user schedule data stored in the wearable device 1.

Further, the wearable device 1 has a function of providing various types of information associated with the user or owner of the wearable device 1. The various types of information associated with the user include, for example, schedule information, weather information, position information concerning the wearable device 1, traffic information, etc.

FIG. 3 is a block diagram showing the system configuration of the computer 10.

As shown, the computer 10 comprises a CPU 111, a system controller 112, a main memory 113, a graphics processing unit (GPU) 114, sound codec 115, a BIOS-ROM 116 and a solid state drive (SSD) 117. The computer 10 further comprises the BT module 40, a wireless LAN module 121, an SD card controller 122, a PCI EXPRESS card controller 123, an embedded-controller/keyboard-controller IC (EC/KBC) 130, a power supply controller (PSC) 141, a power supply circuit 142, etc.

The CPU 111 is a processor for controlling the operation of each component of the computer 10. The CPU 111 executes various types of software loaded from the SSD 117 to the main memory 113. The software includes an operating system (OS) 201 and a control program 202.

The control program 202 is a program that cooperates with the wearable device 1 to provide various functions. For instance, the control program 202 can execute a function of synchronizing data between the computer 10 and the wearable device 1 using wireless communication, a function of controlling lock/unlock of the computer 10, a function of controlling the valid/invalid of the touch pad 14.

Also, the CPU 111 also executes a basic input output system (BIOS) stored in the BIOS-ROM 116. BIOS is a system program for controlling hardware.

The GPU 114 is a display controller configured to control the LCD 31 used as the display monitor of the computer 10. The GPU 114 generates a display signal (LVDS signal) to be supplied to the LCD 31, based on the display data stored in the video memory (VRAM) 114A. The GPU 114 can also generate an analog RGB signal and a HDMI video signal from the display data. The analog RGB signal is supplied to an external display via the RGB port 24.

The HDMI output terminal 23 can provide the external display with the HDMI video signal (non-compressed digital video signal) and a digital audio signal via a single cable. An HDMI control circuit 119 is an interface configured to provide the external display with the HDMI video signal and the digital audio signal via the HDMI output terminal 23.

The system controller 112 is a bride device configured to connect the CPU 111 to each component. The system controller 112 contains a serial ATA controller configured to control the SSD 117. Further, the system controller 112 executes communication with each device on a Low PIN Count (LPC) bus.

The EC/KBC 130 is connected to the LPC bus. The EC/KBC 130, the power supply controller (PSC) 141 and the battery 20 are connected to each other via a serial bus, such as an I² bus.

The EC/KBC 130 is a power management controller configured to execute the power management of the computer 10. The EC/KBC 130 is realized as a one-chip microcomputer containing a keyboard controller configured to control, for example, the keyboard (KB) 13 and the touch pad 14.

The EC/KBC 130 has a function of powering on and off the computer 10 in accordance with a user operation of the power supply switch 16. The control of power-on and -off of the computer 10 is performed by the cooperation of the EC/KBC 130 and the power supply controller (PSC) 141. Upon receiving an ON signal from the EC/KBC 130, the power supply controller (PSC) 141 controls the power supply circuit 142 to power on the computer 10. In contrast, upon receiving an OFF signal from the EC/KBC 130, the power supply controller (PSC) 141 controls the power supply circuit 142 to power off the computer 10. The EC/KBC 130, the power supply controller (PSC) 141, and the power supply circuit 142 are powered by the power from the battery 20 or an AC adaptor 150 even when the computer 10 is powered off.

The power supply circuit 142 generates power (operation power) to be supplied to each component, using power from the AC adaptor 150 connected as an external power supply to the computer main unit 11.

FIG. 4 is a block diagram showing the system configuration of the wearable device 1.

The wearable device 1 comprises a system controller 91, a memory 92, a clock module 93, a BT module 4, a sensor hub 94, an EC 102, a power supply circuit 103, etc.

The system controller 91 is a processor configured to control the operation of each component within the wearable device 1. The system controller 91 executes an operating system (OS) 100 and a control program 101 loaded to the memory 92.

The control program 101 is configured to cooperate with the computer 10 to provide various functions. For instance, the control program 101 is used to perform data synchronization between the computer 10 and the wearable device 1.

The system controller 91 contains a memory controller for controlling access to the memory 92. The system controller 91 may also contain a display controller for controlling the display 3 of the wearable device 1.

The clock module 93 is configured to clock a current time point. The sensor hub 94 is connected to the acceleration sensor 5 as a movement sensor. By virtue of the acceleration sensor 5, the movement of the housing formed 2 of the wearable device 1, i.e., the behavior of the user wearing the wearable device 1, can be detected.

The BT module 4 is a communication controller configured to realize short-range wireless communication using BT. In the first embodiment, pairing is already established between the BT module 4 and the BT module 40 incorporated in the computer 10.

The EC 102 is a power management controller configured to execute power management of the wearable device 1. The EC 102 and the power supply circuit 103 are powered by the power from a battery 70 even when the wearable device 1 is powered off. The power supply circuit 103 generates power (operation power) to be supplied to each component, using the power from the battery 70.

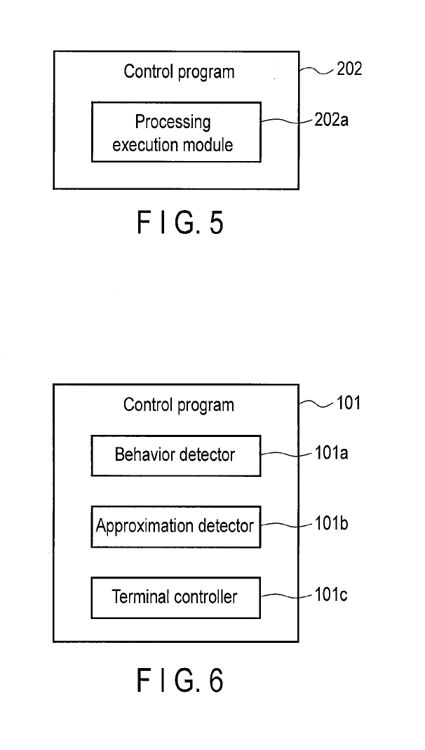

FIG. 5 shows the configuration of the control program 202 executed by the computer 10.

The control program 202 includes a program used to receive information from the wearable device 1 via the BT module 40 and to execute processing corresponding to the information. More specifically, the control program 202 includes a program used to realize a processing execution module 202a.

The processing execution module 202a executes processing for releasing the computer 10 from the locked state, upon receiving, from the wearable device 1, touch information indicating that the user has touched the computer 10.

FIG. 6 shows the configuration of a control program 101 executed by the wearable device 1.

The control program 101 includes a program for controlling the operation of the computer 10 in accordance with a user behavior, based on the signal state of the acceleration sensor 5 and the communication state of the BT module 4.

More specifically, the control program 101 includes a program for realizing a behavior detector 102a, an access detector 102b and a terminal controller 101c. The behavior detector 102a detects a user behavior based on the signal state of the acceleration sensor 5. The user behavior includes, for example, a user behavior of touching the computer 10, and that of leaving the computer 10. The access detector 102b detects a user access state with respect to the computer 10, based on the communication state of the BT module 4. In this case, if a state communicable with the computer 10 via the BT module 4 is established, it is determined that the user is near the computer 10.

If the behavior detector 102a has detected a state in which the user touches something, and if the access detector 102b has determined that the user is near the computer 10, the terminal controller 101c determines that “something” touched by the user is the computer 10, and sends, via the BT module 4, touch information indicating that the user has touched the computer 10.

Before describing the operation of the system, a method of releasing the locked state of the computer 10, using the wearable device 1, will be described.

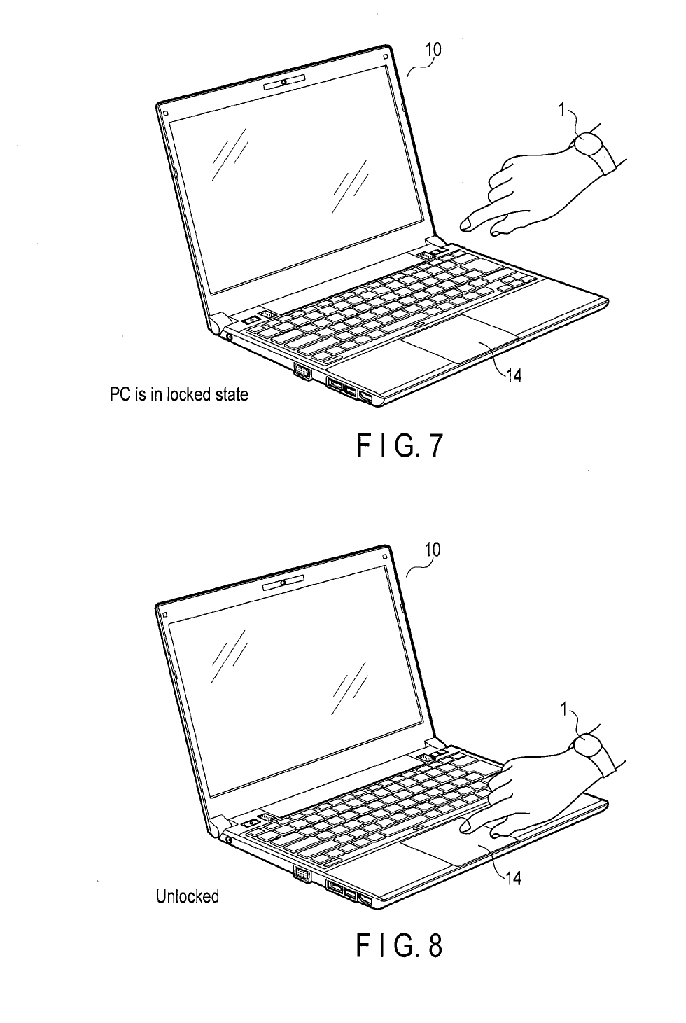

FIG. 7 shows a state in which the computer 10 is in the locked state. At this time, the user is away from the computer 10. FIG. 8 shows a state in which the user touches the computer 10. In this example, the user touches the touch pad 14 of the computer 10.

The computer 10 and the wearable device 1 are already mutually authenticated via BT (pairing is already established between them). The triaxial acceleration sensor 5 that can detect at least x-, y- and z-directional movements is provided in the wearable device 1. When the user wears the wearable device 1, the movement of the housing formed 2 corresponding to the behavior of the user is detected by the acceleration sensor 5. In particular, when the user has attached the housing formed 2 of the wearable device 1 to a wrist 6, the movement of the wrist 6 can be read from the signal pattern of the acceleration sensor 5.

Further, the wearable device 1 has a BT function (BT module 4). It can be determined from the communication state of the BT module 4 whether the user is approaching the computer 10. Therefore, if the acceleration sensor 5 has detected that the user “has touched something,” and if the BT module 4 has detected that the user “is approaching the computer 10,” it is determined that “something” touched by the user is the computer 10.

When the wearable device 1 has determined that the user has touched the computer 10, it sends to the computer 10 via the BT module 4 touch information indicative of this action. Upon receiving the touch information via the BT module 40, the computer 10 releases its locked state.

In general, the computer 10 is set in the locked state if no input operation is detected within a predetermined time period. Further, in general, to release the locked state, the user must perform a troublesome operation to, for example, input a password. However, if the system of the embodiment is used, the user can release the locked state simply by touching the computer 10.

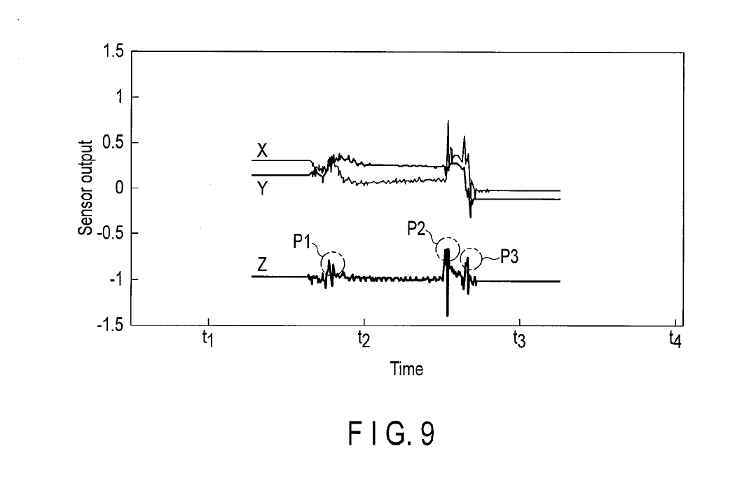

FIG. 9 shows the signal waveforms of the triaxial accelerator sensor 5 employed in the wearable device 1. In the figure, X, Y and Z indicate an x-axis signal, a y-axis signal and a z-axis signal, respectively.

When the user moves a hand, changes occur in triaxial signals output from the acceleration sensor 5. Attention will now be paid to the change in the z-axis (vertical) signal. P1 indicates a state assumed when the user slightly moves the hand in front of the computer 10, P2 indicates a state assumed when the user has touched the computer 10, and P3 indicates a state assumed when the user places the hand on the palm rest of the computer. It can be understood that when the user has touched the computer 10, the z-axis signal instantly rises to a predetermined level or higher.

The same will occur in the x-axis and y-axis signals. Namely, when the user has touched the computer 10, the signals significantly change. Accordingly, if the patterns of changes in the signals of the acceleration sensor 5 are analyzed, it can be understood that the user “has touched something.” At this time, if the analysis result is combined with the communication state of the BT module, it can be detected that “something” touched by the user is the computer 10.

The operation of the above system will be described.

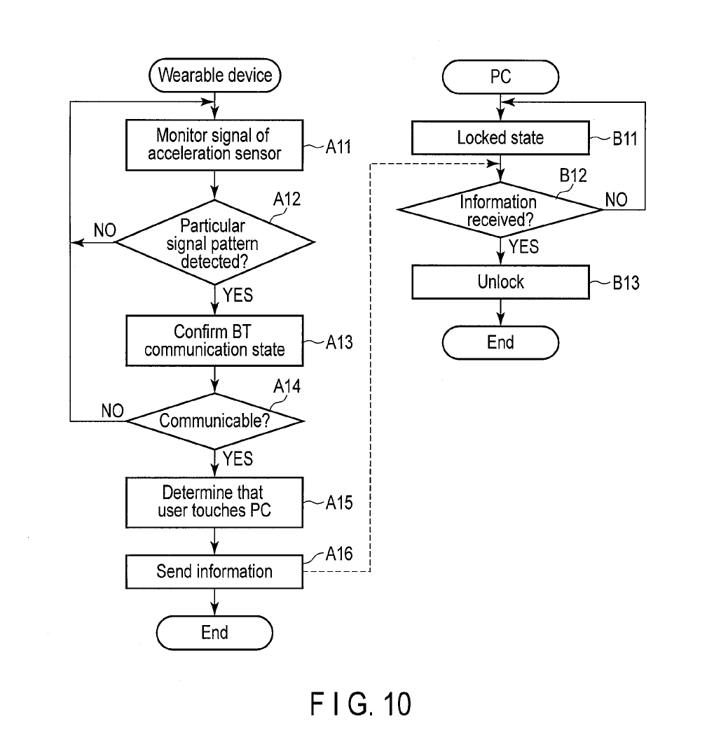

FIG. 10 is a flowchart showing the operations of the wearable device 1 and computer 10 of the first embodiment. Note that in each of the flowcharts described below, processing at the wearable device 1 is executed by causing the system controller 91 to read, from the memory 92, a program associated with the processing and included in the control program 101. Similarly, processing at the computer 10 is executed by causing the CPU 111 to read, from the main memory 113, a program associated with the processing and included in the control program 202.

The user behaves with the wearable device 1 attached to the wrist 6. The system controller 91 of the wearable device 1 monitors triaxial signals output from the acceleration sensor 5 (step A11).

If a particular signal pattern occurring when the user has touched something is detected (Yes in step A12), the system controller 91 confirms the communication state of the BT module 4 (step A13). If the communication state indicates that the BT module is communicable with the computer 10 (Yes in step A14), the system controller 91 determines that the user touches the computer 10 (step A15), thereby sending touch information to the computer 10 via the BT module 4 (step A16).

At the computer 10, if there is no input operation within a predetermined time period, a locked state is set (step B11). The “locked state” means a state in which any input operation is unacceptable in the computer 10. At this time, for instance, the display screen of the computer is concealed by, for example, a screen saver.

When the BT module 40 of the computer 10 has received the user touch information from the wearable device 1 (Yes in step B12), the CPU 111 of the computer 10 releases the locked state to enable the computer 10 to be used (step B13).

As described above, in the first embodiment, the behavior of the user is detected by the wearable device 1. If the user touches the computer 10, touch information indicative of this action is sent via the BT module 4. Thus, without any troublesome operation for releasing the locked state, the computer 10 recognizes the approach of the user and releases itself from the locked state to be set in a usable state. In contrast, if a third party who does not wear the wearable device 1 has touched the computer 10, the locked state is not released, with the result that the security of the computer 10 is maintained.

In the flowchart of FIG. 10, the communication state of the BT module 40 is detected after detecting the signal state of the acceleration sensor 5 (A1→A12→A13→A14). Alternatively, the signal state of the acceleration sensor 5 may be detected after detecting the communication state of the BT module 40 (A14→A13→A12→A11).

### Second Embodiment

A second embodiment will be described.

The second embodiment employs a function of confirming the strength of a BT signal at the computer 10, as well as the structure of the first embodiment.

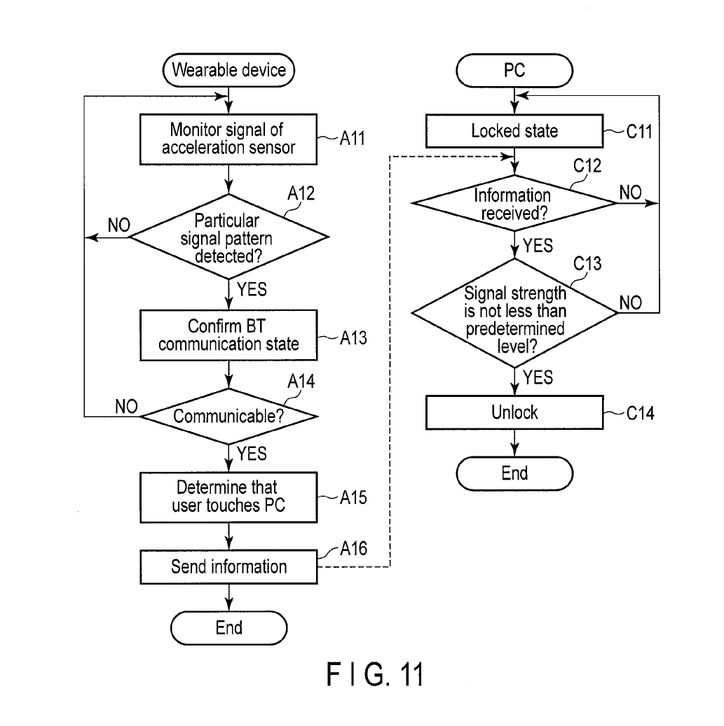

FIG. 11 is a flowchart showing the operations of the wearable device 1 and the computer 10 in the second embodiment. In FIG. 11, the processing performed in the wearable device 1 is similar to the corresponding processing of the first embodiment shown in FIG. 10.

Namely, when a state in which the user touches the computer 10 has been detected based on the signal state of the acceleration sensor 5 and the communication state of the BT module 4 (steps A11 to A15), the wearable device 1 sends user touch information to the computer 10 (step A16).

At the computer 10, if there is no input operation within a predetermined time period, a locked state is set (step C11). When the BT module 40 of the computer 10 has received the user touch information from the wearable device 1 (Yes in step C12), the CPU 111 of the computer 10 confirms the current signal strength detected by the BT module 40 (step C13).

If a signal of a certain level or higher is confirmed (Yes in step C13), the CPU 111 releases the locked state to enable the computer 10 to be used, in accordance with the user touch information received from the wearable device 1 (step C14).

As described above, in the second embodiment, the locked state is released in the computer 10 after confirming the BT signal strength. This prevents the locked state from being erroneously released when, for example, the user is away from the computer 10.

### Third Embodiment

A third embodiment will be described.

The third embodiment employs a function of confirming a user input operation at the computer 10, as well as the structure of the first embodiment.

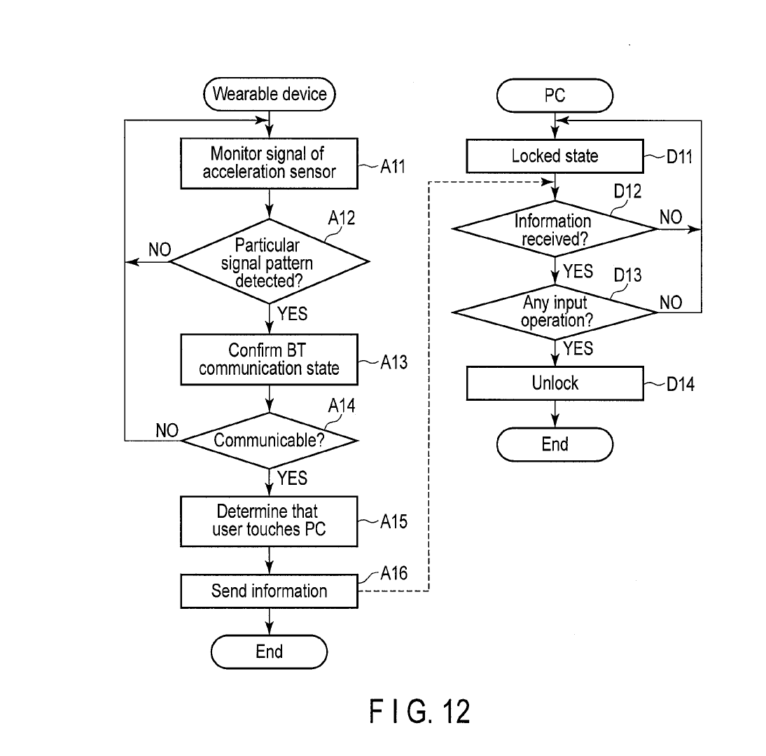

FIG. 12 is a flowchart showing the operations of the wearable device 1 and the computer 10 in the third embodiment. In FIG. 12, the wearable device 1 performs the same processing as that of the first embodiment shown in FIG. 10.

Namely, when a state in which the user touches the computer 10 has been detected based on the signal state of the acceleration sensor 5 and the communication state of the BT module 4 (steps A11 to A15), the wearable device 1 sends user touch information to the computer 10 (step A16).

At the computer 10, if there is no input operation within a predetermined time period, a locked state is set (step D11). When the BT module 40 of the computer 10 has received the user touch information from the wearable device 1 (Yes in step D12), the CPU 111 of the computer 10 confirms whether there is an input operation (step D13). The “input operation” includes, for example, a touch operation to the touch pad 14, as well as an operation of the keyboard 13.

If it is confirmed that there is an input operation (Yes in step D13), the CPU 111 releases the computer 10 from the locked state to set it in a usable state in accordance with the touch information received from the wearable device 1 (step D14).

As described above, in the third embodiment, the locked state of the computer 10 is released after the input operation is confirmed at the computer 10. This can prevent the computer 10 from, for example, being erroneously released from the locked state when the user is away from the computer 10.

### Fourth Embodiment

A fourth embodiment will be described.

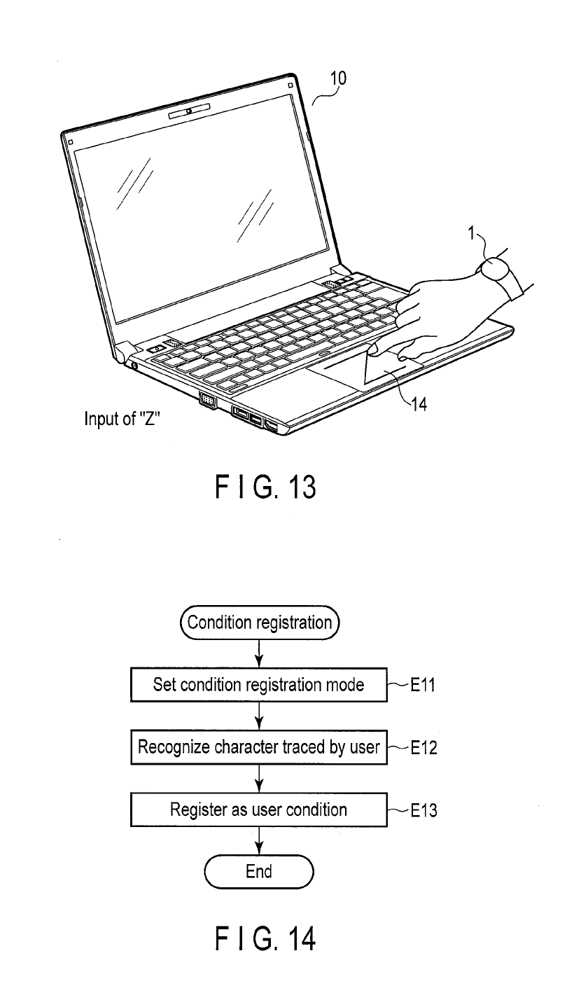

The fourth embodiment employs a function of confirming an input of a predetermined character at the computer 10, as well as the structure of the first embodiment. As shown in FIG. 13, the touch pad 14 of the computer 10 has a gesture function for recognizing a character. When an input of a predetermined character (“Z” in this case) has been confirmed upon receiving user touch information from the wearable device 1, the computer 10 is released from the locked state.

The operations of the fourth embodiment performed (a) at the time of condition registration and (b) at the time of operating the PC will be described in detail.

(a) At the time of condition registration

FIG. 14 is a flowchart showing an operation performed in the fourth embodiment when a computer condition for the computer 10 is registered. The processing indicated by this flowchart is executed by causing the CPU 111 of the computer 10 to read, from the main memory 113, a program associated with this operation and included in the control program 202.

Firstly, a condition registration mode is set by operating the computer 10 (step E11). At this time, if the user moves a finger on the touch pad 14 of the computer 10 to trace an arbitrary character, this character is recognized by the gesture function employed in the touch pad 14 (step E12). The CPU 111 registers the recognized character as a user condition in a predetermined area in the memory 92 (step E13).

For instance, supposing that the user has traced a character “Z” on the touch pad 14, the character “Z” is registered as the user condition.

(b) At the time of operating the PC

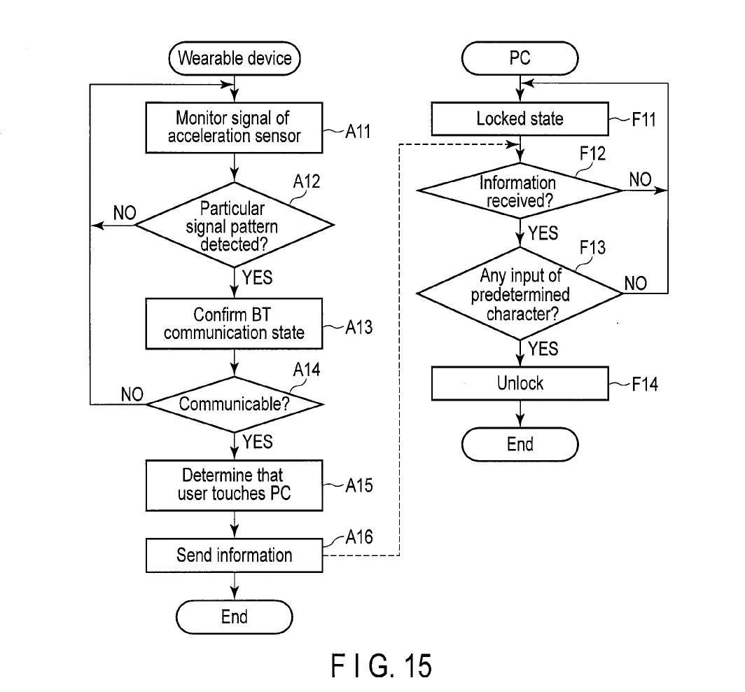

FIG. 15 is a flowchart showing the operations of the wearable device 1 and the computer 10 in the fourth embodiment. In FIG. 15, processing at the wearable device 1 is similar to that of the first embodiment shown in FIG. 10.

Namely, when a state in which the user touches the computer 10 has been detected based on the signal state of the acceleration sensor 5 and the communication state of the BT module 4 (steps A11 to A15), user touch information is sent from the wearable device 1 to the computer 10 (step A16).

At the computer 10, if there is no input operation within a predetermined time period, a locked state is set (step F11). When the BT module 40 of the computer 10 has received the user touch information from the wearable device 1 (Yes in step F12), the CPU 111 of the computer 10 determines whether a predetermined character has been input on the touch pad 14 (step F13).

The “predetermined character” is the character (e.g., “Z”) mentioned above referring to FIG. 14 and registered as the user condition.

If the predetermined character has been input (Yes in step F13), the CPU 111 releases the computer 10 from the locked state to thereby set it in a usable state in accordance with the user touch information received from the wearable device 1 (step F14).

As described above, in the fourth embodiment, when the input of a character pre-registered at the computer 10 has been confirmed, the locked state is released. Accordingly, even if a third party, for example, utilizes the wearable device 1 to touch the computer 10, the locked state can be maintained.

### Fifth Embodiment

A fifth embodiment employs, also at the wearable device 1, a function of confirming an input of a character, as well as the structure of the fourth embodiment. If an input of a predetermined character has been confirmed at both the wearable device 1 and the computer 10, the computer 10 is released from the locked state.

In this case, also at the wearable device 1, such condition registration as described referring to FIG. 14 is needed. Namely, the user traces an arbitrary character on the touch pad 14 of the computer 10, with the wearable device 1 attached to the wrist 6. The movement of the wearable device 1 corresponding to the movement of the user at this time is detected by the acceleration sensor 5.

The wearable device 1 recognizes the user's traced character from the path of the movement of the wearable device 1, and registers the character as a user activation condition in a predetermined area in the memory 92. In the example of FIG. 13, the character “Z” is registered as the user condition at both the computer 10 and the wearable device 1.

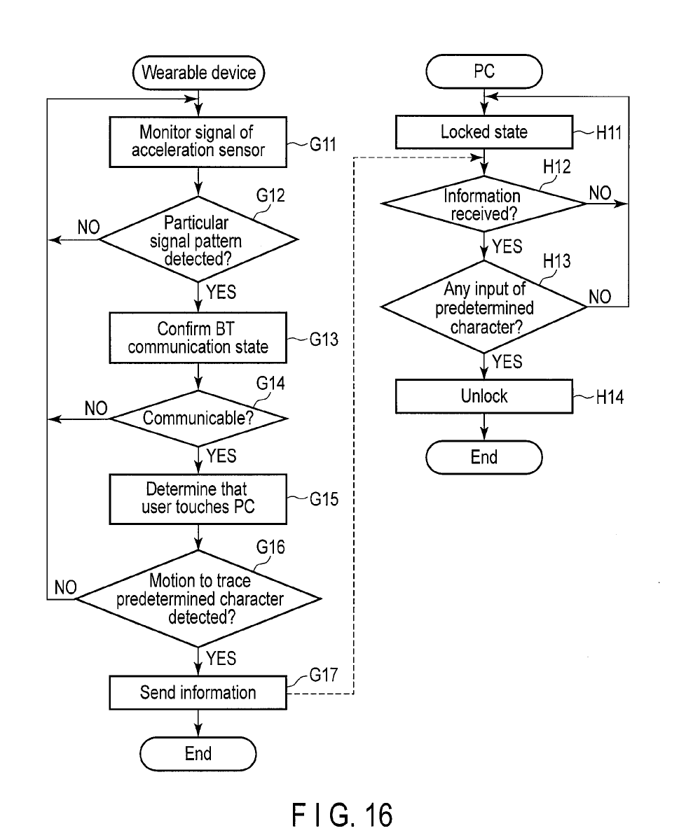

FIG. 16 is a flowchart showing the operations of the wearable device 1 and the computer 10 in the fifth embodiment. In FIG. 16, steps G11 to G15 at the wearable device 1 are the same as steps A11 to A15 of the first embodiment. Namely, a state in which the user touches the computer 10 is detected based on the signal state of the acceleration sensor 5 and the communication state of the BT module 4 (steps G11 to G15).

In the fifth embodiment, when the acceleration sensor 5 of the wearable device 1 has detected a movement corresponding to the character (e.g., “Z”) pre-registered as the user condition (Yes in step G16), the system controller 91 of the wearable device 1 sends touch information to the computer 10 (step G17).

At the computer 10, if there is no input operation within a predetermined time period, a locked state is set (step H11). When the BT module 40 of the computer 10 has received the user touch information from the wearable device 1 (Yes in step H12), the CPU 111 of the computer 10 determines whether the character pre-registered as the user condition has been input (step H13).

If the character registered as the user condition has been input (Yes in step H13), the CPU 111 releases the computer 10 from the locked state to thereby set it in a usable state in accordance with the user touch information received from the wearable device 1 (step H14).

As described above, in the fifth embodiment, only when the input of a character pre-registered at both the wearable device 1 and the computer 10 has been confirmed, the locked state is released. This further enhances the security of the computer 10, compared to the structure of the fourth embodiment.

### Sixth Embodiment

A sixth embodiment will be described.

In the first to fifth embodiments, methods for releasing the locked state of the computer 10 using the wearable device 1 have been described. In the sixth embodiment, a description will be given of a method of locking the computer 10 using the wearable device 1.

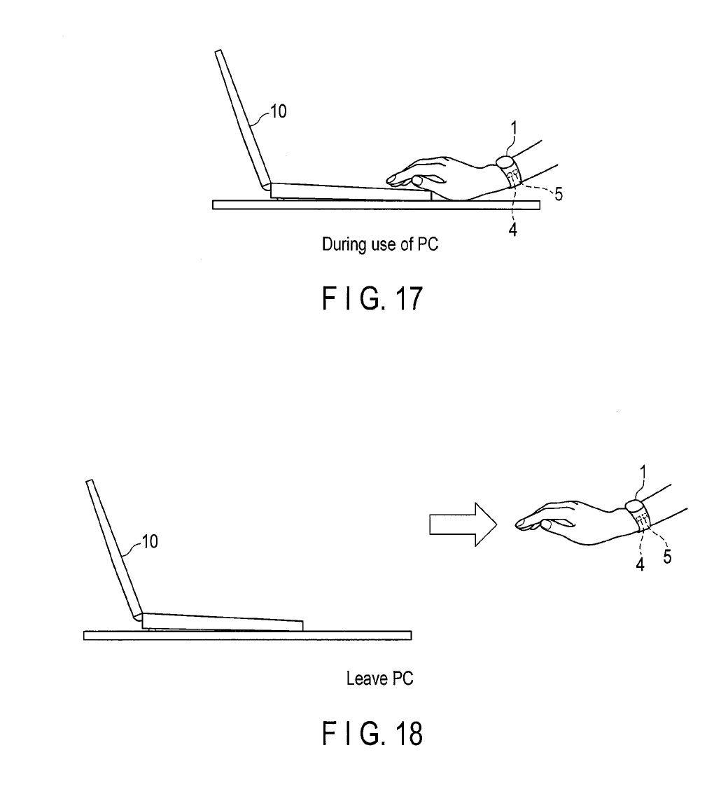

FIG. 17 shows a state in which the computer 10 of the sixth embodiment is being used by a user. FIG. 18 shows a state in which the user leaves the computer 10.

The user wears the wearable device 1 on the wrist 6. The wearable device 1 is provided with the BT module 4 and the acceleration sensor 5, and the behavior of the user is detected by the acceleration sensor 5. In this case, when the user is using the computer 10 as shown in FIG. 17, the triaxial signal output from the acceleration sensor 5 is relatively stable.

When the user has left the computer 10 as shown in FIG. 18, the movement of the user at this time is detected as a change in the signal of the acceleration sensor 5. Accordingly, if the acceleration sensor 5 has detected that the user has moved from a current position, and if the BT module 4 has detected a state in which the wearable device 1 is communicable with the computer 10, it is determined that the user has left the computer 10. In this case, considering that the user may have moved to a position near the computer 10 and soon return, it is assumed that the acceleration sensor 5 detects whether the user has moved a predetermined distance (e.g., about five steps) or more.

If the wearable device 1 determines that the user has left the computer 10 and moved the predetermined distance or more, it sends to the computer 10 via the BT module 4 leaving information indicative of this. Upon receiving the leaving information, the computer 10 confirms whether there is a user input operation. If there is no user input operation, and the recognition of the computer 10 coincides with that of the wearable device 1, the computer 10 determines that the user has left, and executes lock processing.

In general, the locking function of the computer 10 is activated when there is on input operation within a predetermined time period. In contrast, in the system of this embodiment, the computer 10 is automatically locked when the user has left the computer 10. Thus, any operation for setting the locked state is not necessary.

The operation of the system according to the sixth embodiment will be described.

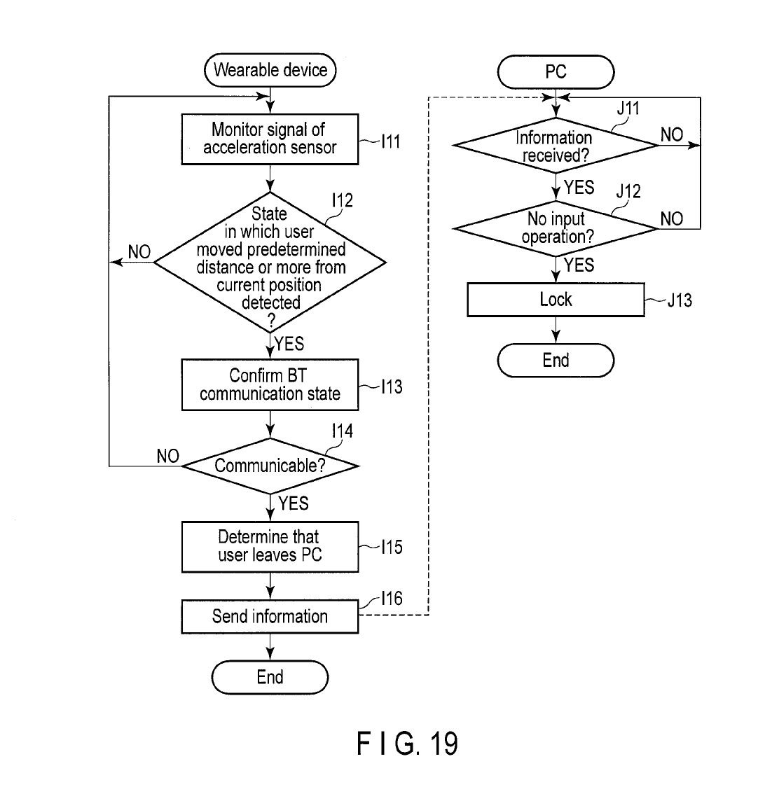

FIG. 19 is a flowchart showing the operations of the wearable device 1 and the computer 10 in the sixth embodiment.

The user behaves with the wearable device 1 attached to the wrist 6. The system controller 91 of the wearable device 1 monitors triaxial signals output from the acceleration sensor 5 (step I11).

As described above referring to FIGS. 17 and 18, when the user is using the computer 10, the triaxial signal output from the acceleration sensor 5 is relatively stable. Further, when the user has left the computer 10, the movement at this time is detected as a change in the signal of the acceleration sensor 5.

If a state in which the user has moved a predetermined distance or more from a current position is detected from a change in the signal of the acceleration sensor 5 (Yes in step I12), the system controller 91 confirms the communication state of the BT module 4 (step I13). If the communication state indicates that the BT module is communicable with the computer 10 (Yes in step I14), the system controller 91 determines that the user has left the computer 10 (step I15), thereby sending leaving information to the computer 10 via the BT module 4 (step I16).

If it is determined in step I12 that the distance by which the user has moved is the predetermined value or less, it is considered that the user is still near the computer 10 and may soon return. Further, if it is determined in step I14 that the wearable device 1 is incommunicable with the computer 10, it is considered that the user is not using the computer 10 and is in another place.

On the other hand, when the CPU 111 of the computer 10 has received the leaving information from the wearable device 1, using the BT module 40 (Yes in step J11), it determines whether there is an input operation (step J12). The “input operation” includes, for example, a touch operation on the touch pad 14, as well as an operation of the keyboard 13.

If there is no input operation (Yes in step J12), the CPU 111 locks the computer 10 to set it in an unusable state in accordance with the leaving information (step J13).

As described above, in the sixth embodiment, when the user has left the computer 10, the computer 10 is locked and secured.

### Seventh Embodiment

A seventh embodiment will be described.

When a single computer 10 is shared among a plurality of users, it is necessary to perform authentication for each user. In general, it is necessary to input IDs or passwords unique to respective users so as to log into the computer 10. The seventh embodiment presupposes such user's personal authentication.

The wearable device 1 and the computer 10 in the seventh embodiment are similar in basic structure to those of the first to sixth embodiments. However, in the seventh embodiment, at the wearable device 1, pre-registered user's personal information (ID, password, etc.) is stored in the memory 92 shown in FIG. 4. The personal information is managed on the OS 100. Similarly, at the computer 10, personal information (ID, password, etc.) associated with each user pre-registered as a PC joint owner is stored in the main memory 113 shown in FIG. 3. These personal information items are managed on the OS 201.

The operation of the system of the seventh embodiment will be described.

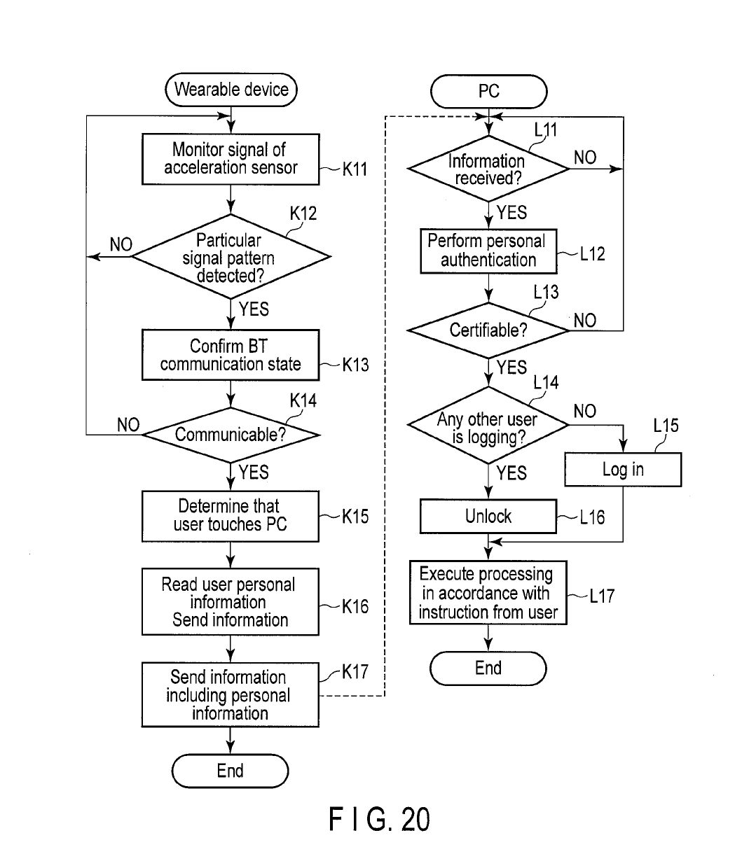

FIG. 20 is a flowchart for explaining the operations of the wearable device 1 and the computer 10 in the seventh embodiment. In FIG. 20, steps K11 to K15 at the wearable device 1 are similar to steps A11 to A15 of the first embodiment shown in FIG. 10. Namely, a state in which the user touches the computer 10 is detected based on based on the signal state of the acceleration sensor 5 and the communication state of the BT module 4 (steps K11 to K15).

In the seventh embodiment, the system controller 91 of the wearable device 1 reads user's personal information (ID, password, etc.) from the memory 92 (step K16). The personal information is already registered by a predetermined operation performed by a user as the owner of the wearable device 1. The system controller 91 sends the personal information to the computer 10 via the BT module 4, along with user touch information (step K17).

At the computer 10, when the BT module 40 of the computer 10 has received the user touch information and personal information from the wearable device 1 (Yes in step L11), the CPU 111 of the computer 10 performs user's personal authentication, using the received personal information (step L12). More specifically, the CPU 111 compares the received personal information with personal information associated with respective users and pre-registered in the main memory 113 as PC joint owners. If the received personal information exists in the main memory 113, the CPU 111 determines that the user is a PC joint owner (Yes in step L13).

At this time, the CPU 111 determines whether any other user is logging into the computer 10 (step L14). If no other user is logging into it (No in step L14), the CPU 111 permits the user authenticated in step L12 to log into the computer 10 (step L15), and executes processing in accordance with a user's instruction (step L17).

In contrast, if another user is logging into the computer 10 (Yes in step L14), the CPU 111 unlocks the computer 10 to enable the user authenticated in step L12 to log in (step L16), and then executes processing based on the user's instruction (step L17).

As described above, in the seventh embodiment, even when a single computer 10 is shared among a plurality of users, each user can be authenticated to be able to operate the computer 10, simply by touching the same.

At least one of the above-described embodiments can provide an electronic device, system and method capable of controlling the operation of a device as an operation target in accordance with the behavior of the user.

Although in each of the embodiments, an acceleration sensor is used to detect the behavior of the user, another type of a movement sensor, such as a gyro sensor, may be used along with the acceleration sensor to detect the behavior of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device attachable to a user, comprising:
a sensor configured to detect movement of the electronic device;
a first controller configured to wirelessly communicate with a terminal device; and
a second controller configured to control the terminal device based on a signal state of the sensor and a communication state of the first controller.

2. The electronic device of claim 1, wherein the second controller comprises:
a behavior detector configured to determine information indicative of a behavior of the user based on the signal state of the sensor;
an approximation detector configured to determine information indicative of an approximation state of the user to the terminal device based on the communication state of the first controller; and
a terminal controller configured to determine, when the behavior detector determines that the user touches an object and the approximation detector determines that the user is near the terminal device, that the object touched by the user is the terminal device and release the terminal device from a locked state.

3. The electronic device of claim 1, wherein the second controller comprises:
a behavior detector configured to determine information indicative of a behavior of the user based on the signal state of the sensor;
an approximation detector configured to determine information indicative of an approximation state of the user to the terminal device based on the communication state of the first controller; and
a terminal controller is configured to determine, when the behavior detector determines that the user moves from a current position and the approximation detector determines that the user is still near the terminal device, that the user leaves the terminal device and set the terminal device in the locked state.

4. The electronic device of claim 2, further comprising a memory storing user's personal information,
wherein the terminal controller is configured to determine, when the behavior detector determines that the user touches an object and the approximation detector determines that the user is near the terminal device, that the object touched by the user is the terminal device, send the user's personal information stored in the memory to the terminal device, and make the terminal device execute processing corresponding to the user.

5. The electronic device of claim 1, wherein the sensor comprises an acceleration sensor configured to detect at least x-directional, y-directional and z-directional movements.

6. The electronic device of claim 1, further comprising a housing formed like a wrist watch attachable to a wrist of the user.

7. A system comprising an electronic device attachable to a user, and a terminal device configured to be wirelessly connected to the electronic device,
wherein
the electronic device comprises:
a sensor configured to detect movement of the electronic device;
a first controller configured to wirelessly communicate with the terminal device; and
a second controller configured to control the terminal device based on a signal state of the sensor and a communication state of the first controller; and
wherein
the terminal device comprises:
a third controller configured to wirelessly communicate with the electronic device; and
a fourth controller configured to receive information from the electronic device via the third controller, and to execute processing corresponding to the information.

8. The system of claim 7,
wherein
the second controller of the electronic device comprises:
a behavior detector configured to determine information indicative of a behavior of the user based on the signal state of the sensor;
an approximation detector configured to
determine information indicative of an approximation state of the user to the terminal device based on the communication state of the first controller; and
a terminal controller configured to determine, when the behavior detector determines that the user touches an object and the approximation detector determines that the user is near the terminal device, that the object touched by the user is the terminal device, and to send via the first communication modulation information indicative of the user touching the terminal device, and
wherein
the fourth controller of the terminal device comprises a processing execution controller configured to execute processing for releasing the terminal device from a locked state, when receiving from the terminal controller via the third controller, information indicative of the user touching the terminal device.

9. The system of claim 8, wherein when the terminal device receives information indicative of the user touching the terminal device from the terminal controller via the third controller, the processing execution controller of the terminal device is configured to execute processing for releasing the terminal device from the locked state, based on a signal strength detected by the third controller.

10. The system of claim 8, wherein when the terminal device receives information indicative of the user touching the terminal device from the terminal controller via the third controller, the processing execution controller of the terminal device is configured to execute processing for releasing the terminal device from the locked state, based on an input operation made by the user.

11. The system of claim 8, wherein when the terminal device receives information indicative of the user touching the terminal device from the terminal controller via the third controller, the processing execution controller of the terminal device is configured to execute processing for releasing the terminal device from the locked state, based on an input of a pre-registered character.

12. The system of claim 8, wherein
when the behavior detector of the electronic device determines movement to trace a pre-registered character, the terminal controller of the electronic device is configured to send information indicative of the user touching the terminal device via the first controller; and
when the terminal device receives information indicative of the user touching the terminal device from the terminal controller via the third controller, the processing execution controller of the terminal device is configured to execute processing for releasing the terminal device from the locked state, based on an input of the pre-registered character.

13. The system of claim 8, wherein
when the behavior detector of the electronic device determines that the user moves from a current position and the approximation detector of the electronic device determines that the user is near the terminal device, the terminal controller of the electronic device is configured to determine that the user leaves the terminal device, and to send information indicative of the user leaving the terminal device; and
when the terminal device receives, from the terminal controller, information indicative of the user leaving the terminal device, the processing execution controller of the terminal device is configured to execute processing for releasing the terminal device from the locked state, based on whether an input operation is performed.

14. The system of claim 8, wherein
the electronic device further comprises a memory storing user's personal information;
when the behavior detector of the electronic device determines that the user touches an object and the approximation detector of the electronic device determines that the user is near the terminal device, the terminal controller of the electronic device is configured to determine that the object touched by the user is the terminal device, to send to the terminal device the user's personal information stored in the memory, along with information indicative of the user touching the terminal device, and to make the terminal device execute processing corresponding to the user;
the terminal device further comprises an authentication controller configured to authenticate the user based on the user's personal information; and
when the terminal device receives, from the terminal controller of the electronic device, the information indicative of the user touching the terminal device, along with the user's personal information, the processing execution controller of the terminal device is configured to log into the terminal device, based on a result of the authentication.

15. A method using an electronic device attachable to a user, the electronic device comprising a sensor configured to detect movement of the electronic device, and a communication controller configured to wirelessly communicate with a terminal device, the method comprising:
controlling the terminal device based on a signal state of the sensor and a communication state of the communication controller.

16. The method of claim 15, further comprising:
determining information indicative of a behavior of the user based on the signal state of the sensor;
determining information indicative of an approximation state of the user to the terminal device based on the communication state of the communication controller; and
when the user is determined as touching an object and that the user is near the terminal device, determining that the object touched by the user is the terminal device, and releasing the terminal device from a locked state.

17. The method of claim 15, further comprising, when the user is detected as moving from a current position and that the user is still near the terminal device, determining that the user leaves the terminal device, and setting the terminal device in the locked state.

18. The method of claim 15, wherein the electronic device further comprises a memory storing user's personal information, the method further comprises, when the user is detected as touching an object and that the user is near the terminal device, determining that the object touched by the user is the terminal device, sending the user's personal information stored in the memory to the terminal device, and making the terminal device execute processing corresponding to the user.
